(19) United States
(12) Patent Application Publication
(10) Pub. No.: US 2005/0250398 A1
(43) Pub. Date: Nov. 10, 2005

(54) Sealing material

(76) Inventors: Malay Patel, Cochranville, PA (US); Michael James Napolitano, Newark, DE (US); James R. Hanrahan, Newark, DE (US); Chaokang Chu, Hockessin, DE (US)

Correspondence Address: Carol A. Lewis White;W. L. Gore & Associates, Inc., 551 Paper Mill Road, P.O. Box 9206, Newark, DE, 19714-9206, US

(21) Appl. No.: 10/841,041

(22) Filed: May 7, 2004

(51) Int. Cl. B32B 27/32; B32B 27/12

(52) U.S. Cl. 442/40; 442/38; 442/149; 442/131; 442/132; 442/133; 442/6; 442/16

(57) ABSTRACT

A sealing material is presented which can be applied to surfaces and/or to surfaces having seams, cracks, crevices and the like to hinder growth and colonization of bacteria while maintaining adhesion over a wide range of service, or use, conditions. The sealing material includes a fluoropolymer layer, a reinforcing layer and an adhesive for adhering the sealing material to the surface or surfaces to be sealed. The invention combines the inherent anti-stick and hydrophobic properties of fluoropolymers with excellent adhesive characteristics.

### FIELD OF THE INVENTION

The present invention relates to a thermally stable, chemically inert, easily cleaned, hydrophobic material that is an effective barrier to microbial contaminants.

### BACKGROUND OF THE INVENTION

Bacterial contamination of food represents one of the major public health problems worldwide. Food contamination is endemic in underdeveloped countries, and is a major cause of disease and death. It is also a major source of illness in developed countries including the United States. The actual incidence of bacterial food-borne illness is unknown, but the CDC estimates it to be between 7 to 81 million illnesses per year, with over 325,000 hospitalizations, and 5,000 deaths in the U.S. annually. The costs of human illness in the U.S. due to food-borne pathogens are in the billions annually. In addition to the toll of illness and death, contaminated food represents a huge economic loss for many food-processing plants.

Current stringent sanitation procedures in food processing plants are effective in reducing the incidence of bacterial contamination of food, but have not prevented the occurrence of serious outbreaks resulting in death and disability. The current consensus is that the total elimination of pathogenic bacteria from food is unrealistic. For example, the World Health Organization has stated that the total elimination of Listeria monocytogenes (L. monocytogenes) from food is “impractical and may be impossible.” Problems caused by microbial contamination of foods tend to be expensive; particularly if these result in consumer recalls.

Poor sanitation of food contact surfaces, equipment, and processing environments has been a contributing factor in food-borne disease outbreaks, especially those involving L. monocytogenes and Salmonella. Improperly cleaned surfaces promote soil buildup, and, in the presence of water, contribute to the development of bacterial biofilms, which may contain pathogenic microorganisms (Boulange-Peterman and others 1993). Cross contamination occurs when food passes over contaminated surfaces or via exposure to aerosols or condensate that originate from contaminated surfaces (Barnes and others 1999, Boulange-Peterman 1996, Bower and others 1996). Frank and Chmielewski (1997) and Holah and others (1990) demonstrated that the type of food contact surface and topography play a significant role in the inability to decontaminate a surface. Abraded surfaces accumulate soil and are more difficult to clean than smooth surfaces. Surface defects further complicate the removal of soil and bacteria (Boulange-Peterman 1996, and others 1997; Bower and others 1996; Mafu and others 1990), with the result that surviving bacteria can re-grow and produce a biofilm. Bacteria within a biofilm are more resistant to disinfectants, which may assist the survival of Listeria and other food-borne pathogens in the food processing environment (Bower and others 1996). Hence, proper control methods for biofilms are necessary for a safe food processing operation.

L. monocytogenes is a pathogen that occurs widely in both agricultural (e.g., soil, water, and plants) and food processing environments (e.g., air, drains, floors, machinery) (Ryser 1999). L. monocytogenes grows at low oxygen conditions and refrigeration temperatures, and therefore survives for long periods of time in the environment, on foods, in processing plants, and in household refrigerators. Although frequently present in raw foods (dairy, meat, poultry, fruits, and vegetables), it can also be present in ready-to-eat (RTE) foods due to post-processing contamination (Mead 1999a, CDC 2000)

Efforts to control L. monocytogenes have reduced the amount and level of contamination, but it has not been possible to eradicate it from the processing environment nor to eliminate the potential for contamination of finished products. However, because of the serious illness, and even death, that can result in susceptible individuals, it is imperative that industry take stringent measures to control the potential for contaminating RTE foods. Since U.S. regulatory agencies consider L. monocytogenes in RTE foods an adulterant, they request that companies recall product found to contain L. monocytogenes.

One way to reduce contamination is to “build in” hygiene into the equipment used in the food manufacturing facility. The hygienic design of equipment can play an important role in controlling the microbiological safety and quality of the products made.

Cracks and crevices on food processing equipment and infrastructure within the food processing plant are difficult to clean and often can provide safe harbor for foodborne pathogens. High humidity and difficult accessibility combine to make these areas ideal locations for the growth of bacterial biofilms, which are subsequently the source for future cross contamination of foods.

One method to minimize the effect of the cracks and crevices in the equipment is to seal them. Spray applied coatings such as polyurea barrier coatings can be used but have some disadvantages. Complex geometries within the plant make spray applications difficult. Chemicals from foodstuffs, marinades, or sanitizing solutions may degrade the coating materials, and some coatings exhibit poor or reduced adhesion over the broad thermal cycling range of the equipment, such as freezers, ovens and other automated forms of food processing equipment.

Antimicrobial materials may passivate or be rendered ineffective when coated by foodstuffs such as protein fat. Additionally the active antimicrobial ingredients may eventually leach out of the polymer over time and become ineffective.

There exists a need for a thermally stable, chemically inert, easily cleaned, hydrophobic material that is an effective barrier to microbial contaminants.

Accordingly, it is a primary purpose of the present invention to provide a multilayer sealing material that can cover surfaces, seams, cracks and crevices to block or inhibit the growth and colonization of bacteria.

These and other purposes of the present invention will become evident from a review of the following specification.

### SUMMARY OF THE INVENTION

The present invention is a sealing material comprising a multi-layer construction which can be applied to a surface or over seams, cracks and other crevices to block or hinder growth and colonization of bacteria while maintaining adhesion over a wide range of service conditions. The invention combines the inherent anti-stick and hydrophobic properties of fluoropolymers with excellent adhesive characteristics.

The sealing material, which may be in tape, sheet, or other suitable form, comprises in one embodiment a fluoropolymer layer bonded to a reinforcing layer, which in turn is bonded to an adhesive layer. The fluoropolymer layer provides, among other things, good resistance to microbial contamination during use. The reinforcing layer provides support for the fluoropolymer layer as well as a suitable bonding surface for the adhesive layer. In one embodiment, the reinforcing layer comprises a porous material. In an alternative embodiment, the reinforcing layer comprises a composite of a porous material and a second material which is impregnated into at least a portion of the porous material. In one exemplary construction of this embodiment, the reinforcing layer comprises thermoplastic polymer impregnated at least partially into a metal mesh. The reinforcing layer may be bonded to the fluoropolymer layer by any suitable means, such as by providing a separate bonding material or alternatively, in the case of a composite reinforcing layer, using the inpregnated thermoplastic polymer to also bond to the fluoropolymer layer. The adhesive layer is bonded to the reinforcing layer (i.e., oriented on the side of the reinforcing layer opposite the fluoropolymer layer) and comprises any suitable adhesive which can adhere the sealing material to a surface, or surfaces, and withstand the operational conditions to which the sealing material is exposed.

Any fluoropolymer having a surface energy of 25 dynes/cm or less and which is hydrophobic, i.e., having a contact angle of 100° or greater, can be used as the fluoropolymer layer. Fluoropolymers are preferred over other surfaces due to their known hydrophobic character, anti-stick properties and cleanability. Dense PTFE is preferred, and even more preferably densified expanded PTFE (i.e., having a density of 2.2 g/cc or greater), due to, among other things, its excellent cleanability, toughness and barrier properties.

The choice of reinforcing layer is dependent on the desired end use performance in terms of thermal stability, bond strength and environmental resistance. The reinforcing layer supports the fluoropolymer layer and provides a surface to which the adhesive layer can bond. The reinforcing layer can comprise any of metals, ceramics, polymeric materials and composites thereof. Further, the reinforcing layer may be in the form of films, fibers, mesh, weaves, nonwovens, knits and comparable supporting structures. A preferred reinforcing member is a stainless steel mesh impregnated at least partially by a thermoplastic polymer.

The fluoropolymer layer can be bonded to the reinforcing layer by any suitable bonding means, for example, via the thermoplastic polymer in the case of a composite reinforcing layer. Alternatively, a separate adhesive can be used. Preferred adhesives are melt processable fluoropolymers including, but are not limited to, ETFE (ethylene tetrafluoroethylene), EFEP (ethylene fluoroethylenepropylene), PFA (perfluoroacrylate), FEP (fluoroethylenepropylene), THV (a polymer of tetrafluoroethylene, hexafluoropropylene and vinylidene fluoride), PVDC (polyvinylidene chloride) and PVF2 (polyvinylidene fluoride).

The adhesive layer bonded on the other side of the reinforcing layer comprises an attachment adhesive which is used to secure the tape in position during use. The adhesive type will be dictated by the end use requirements. Suitable adhesives for the attachment adhesive can include, but are not limited to, pressure sensitive adhesives, hot melt adhesives, thermosetting adhesives and combinations thereof. The adhesive may be self-fixturing (such as a pressure sensitive adhesive) or may require activation by heat, radiation, light or other techniques known to those skilled in the art. Any suitable adhesive may be used for attaching the multilayer composite sealing material to the surface(s) to be protected. Selection of the adhesive will be dictated by service temperature, application method, environmental and bonding conditions. Examples of adhesive classes suitable in this invention include, but are not limited to, epoxies, acrylics, polyurethanes, cyanoacrylates and hybrids or combinations thereof. The adhesive can be tailored to meet requirements for adhesion to specific surfaces, service temperatures, strengths and cure methods.

The resulting sealing material comprises a thermally stable, chemically inert, easily cleaned, hydrophobic material that is an effective barrier to microbial contaminants and which can be incorporated to cover surfaces, seams, cracks and crevices to block or hinder the growth and colonization of bacteria.

### DESCRIPTION OF THE DRAWINGS

The foregoing summary, as well as the following detailed description of the invention, will be better understood when read in conjunction with the appended drawings. For purposes of illustrating the invention, there are shown in the drawings embodiments which are presently preferred. It should be understood, however, that the invention is not limited to the precise arrangements and instrumentalities shown. In the drawings:

FIGS. 1A, 1B, and 1C are cross-sectional views of alternative embodiments of the sealing material of the present invention.

FIG. 2 is a perspective view of a sealing material of the present invention adhered over a portion of a seam between two surfaces.

### DETAILED DESCRIPTION OF THE INVENTION

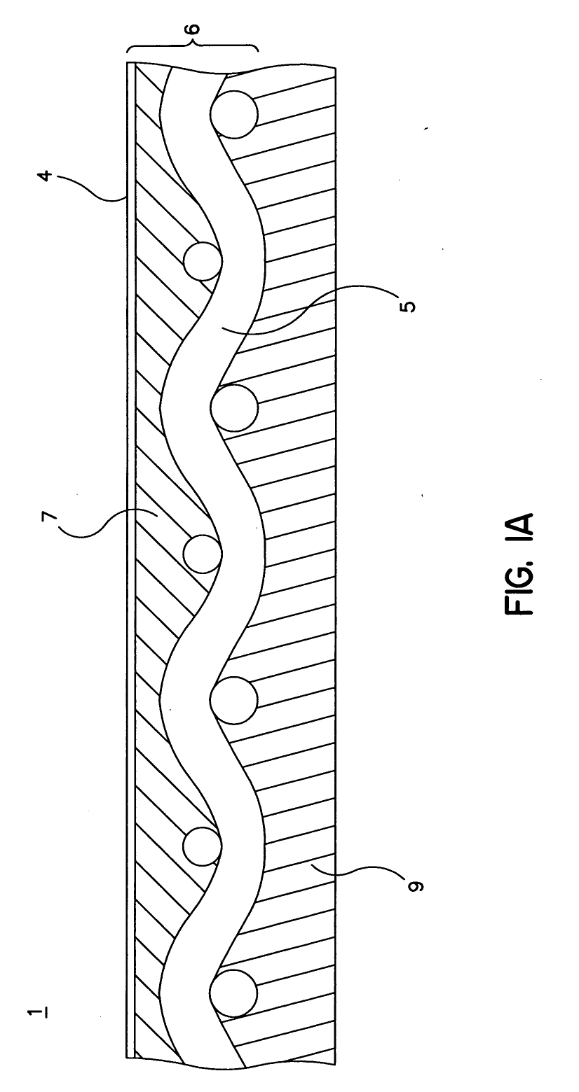

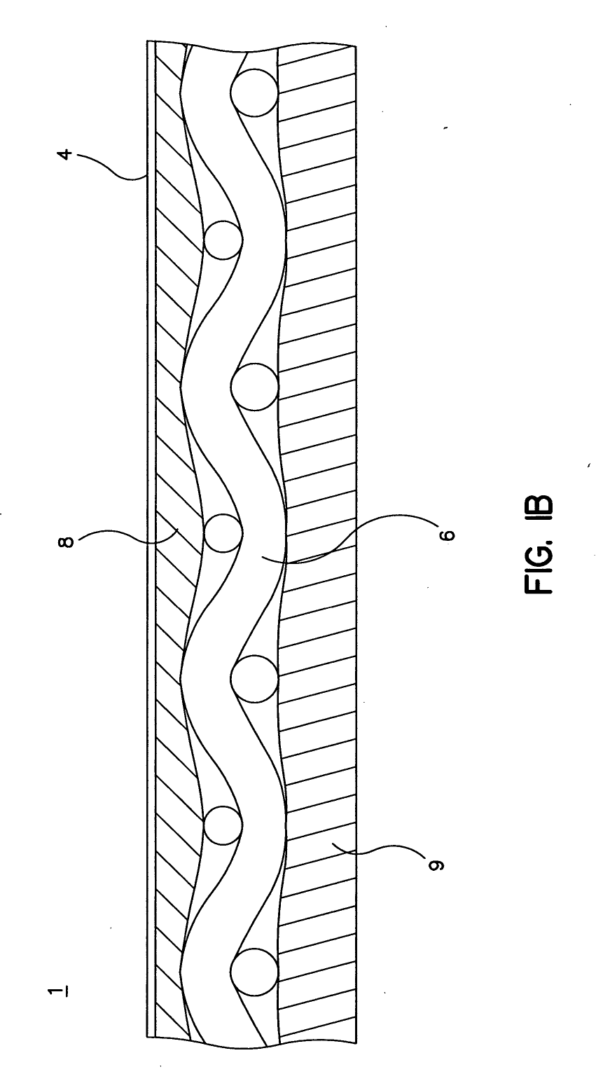

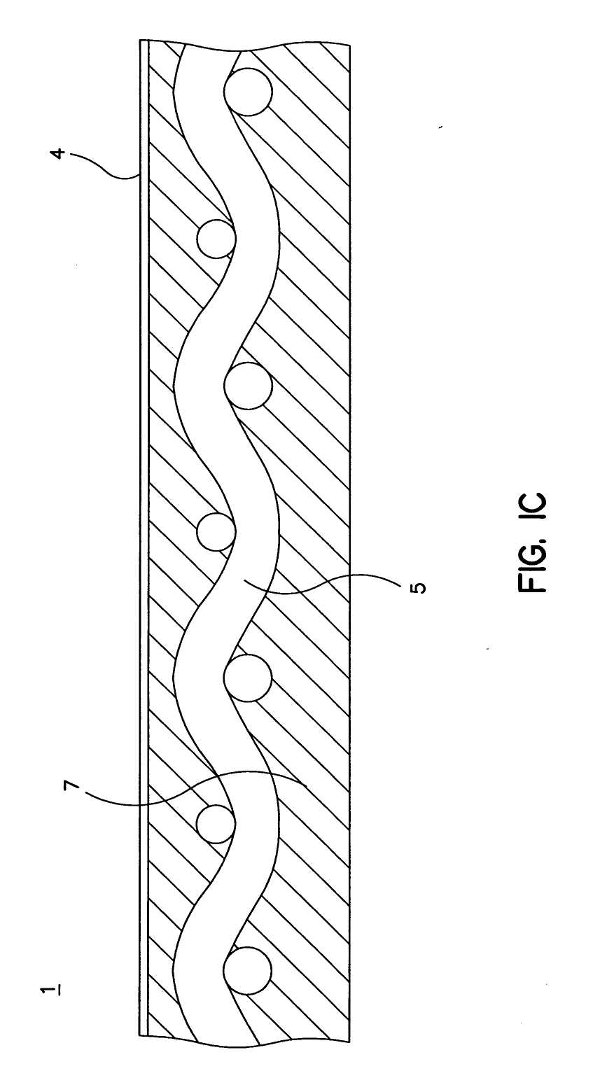

FIGS. 1A-1C illustrate alternative embodiments of a composite sealing material of the present invention. Specifically, referring to FIG. 1A, there is shown a sealing material 1 comprising a fluoropolymer layer 4, bonded to a reinforcing layer 6 comprising a woven or mesh construction 5 and a second material 7, such as a thermoplastic polymer, which at least partially encapsulates the mesh 5. Adhesive layer 9 is bonded to the reinforcing layer 6 on the side opposite the fluoropolymer layer 4. FIG. 1B shows an alternative sealing material 1 comprising fluoropolymer layer 4 bonded to reinforcing layer 6 in this embodiment comprising a woven or mesh material with an adhesive 8. Again, adhesive layer 9 is bonded to the reinforcing layer 6 on the side opposite the fluoropolymer layer 4. FIG. 1C shows a further alternative sealing material 1 wherein thermoplastic material 7 not only encapsulates the mesh 5 to provide a composite reinforcing layer, but also forms a bond with the fluoropolymer layer 4 and extends on the opposite side of the mesh 5 to provide an adhesive layer for adhering the sealing material 1 to a desired surface.

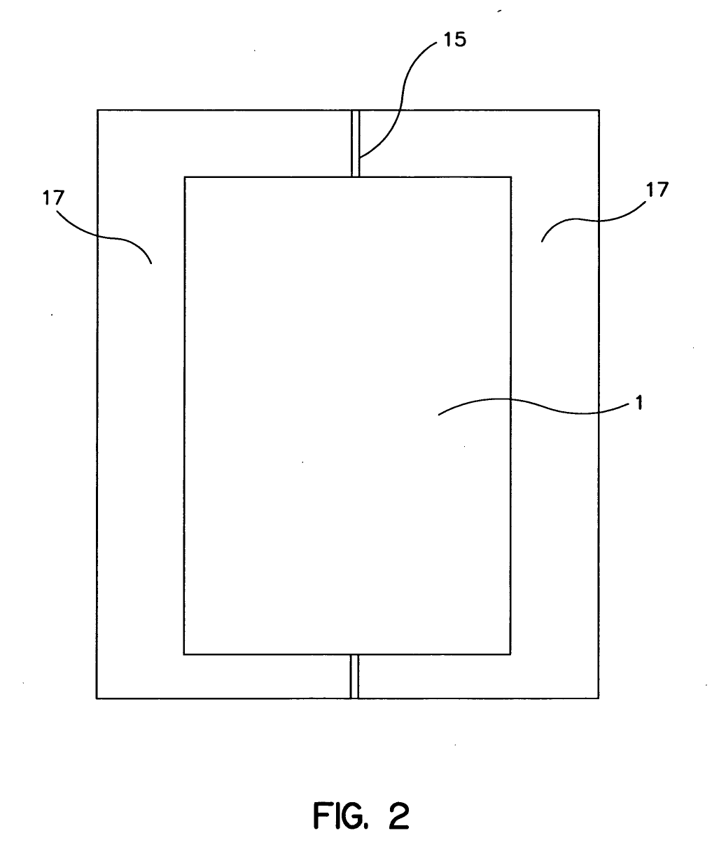

FIG. 2 is a top view of a piece of sealing material 1 adhered over a seam 15 between two abutting surfaces 17, in this particular case two metal panels.

Suitable fluoropolymer layers include any number of fluoropolymers which include, but not limited to, skived PTFE, densified PTFE, whether expanded or not, and densified PTFE with thermoplastic fluoropolymer layers. Example of suitable fluoropolymer layers include any of a number of dense (e.g., bulk density of 2.11 g/cc or greater) PTFE materials available from W. L. Gore & Associates, Inc. Other suitable thermoplastic or melt processable fluoropolymers are available in dispersion, powder, pellet or film forms from several suppliers.

A bonding layer can be utilized to adhere the fluoropolymer layer and the reinforcing layer. While a variety of suitable bonding configurations are contemplated, several exemplary modes of the current invention are described herein and can be practiced depending on the fluoropolymer layer construction. When utilizing melt processable fluoropolymer layers, the fluoropolymer layer can function both as a barrier during use and as an adhesive which can be thermally bonded directly to the reinforcing layer. With a PTFE fluoropolymer layer, an additional adhesive layer is needed to securely bond the PTFE layer to the reinforcing layer. Suitable adhesive layers include lower melt temperature melt processable fluoropolymer such as THV, EFEP, ETFE, and PVF2 to facilitate lower processing temperatures. Higher melt temperature fluoropolymers such as PFA and FEP, etc., can also be used provided higher bonding temperatures are used.

The reinforcing layer may be in the form of a film, mesh, weave nonwoven or knit and can consist of metal, ceramic, polymeric materials and composites thereof. The end use, adhesion requirements and service temperatures desired determine the type and material choice. One example of a suitable reinforcing layer material is a stainless steel mesh.

The attachment adhesive layer secures the multi-layer sealing material to the surface of interest. One possible surface of interest for blocking or inhibiting growth and colonization of bacteria is on cracks and crevices on food processing equipment (e.g, refrigerators, cold storage equipment, etc.) and on food processing plant infrastructures (e.g., walls and divider panels, etc.). In this and similar applications, the sealing material is envisioned to cover exposed crevices. In other applications, the sealing material is envisioned for use on “at-risk” surfaces that could retain, harbor, or promote the growth of bacterial biofilms. The sealing material provides good low temperature (e.g, about 32° F. or below) and high temperature (e.g., about 212° F. or above) adhesion to cover a broad range of equipment operating temperatures and higher temperature cleaning cycles, preferably having a peel strength of at least 5 pli at about 220° F., more preferably at least 7 pli at about 220° F. Preferred also, is a sealing material having a peel strength of at least 5 pli over a temperature range of about 32° F. to about 220° F. Examples of suitable adhesive classes include, but not limited to, epoxies, acrylics, polyurethanes, cyanoacrylates, and hybrids of these. One particular example of a suitable adhesive is an acrylic/epoxy hybrid, such as 3M's Structural Bonding Tape, Part No. 9245, combining the ease of application inherent in a pressure sensitive adhesive with the bond strength of a structural adhesive.

### Measurement and Test Methods

Contact Angle and Surface Energy Measurements

Samples of fluoropolymer films were bonded to glass slides using a pressure sensitive adhesive transfer film. The contact angles were determined for water and diiodomethane using the pendant drop method. A FTA200 Dynamic Contact Angle Analyzer from First Ten Angstroms was used to measure the contact angle. The contact angle was an average of three individual measurements. The Fowkes theory (F. M. Fowkes, Industrial and Engineering Chemistry, 56, 12, 40 (1964)) was used to calculate the surface energy of the fluoropolymer films. The diiodomethane contact angle was used to calculate the dispersive component of the surface energy due to its lack of a polar component in its surface tension. In Table 1, the water and diiodomethane contact angles are presented along with calculated surface energy.

| | Contact Angle (°) | Contact Angle (°) | Surface Energy |
|---|---|---|---|
| | Diiodomethane | Water | mJ/m² |
| PTFE | 69.2 | 116.8 | 23.3 |
| FEP (Dupont | 69.8 | 112 | 23 |
| Teflon FEP) | | | |
| PFA | 70.3 | 109.1 | 22.7 |
| THV (Dyneon | 57.4 | 96 | 30.1 |
| THV 220 g) | | | |

Diiodomethane - Aldrich Chemical 99% purity. Surface tension of 50.8 mN/m for diiodomethane was used in calculating surface energy

Peel Strength—(ASTM D429-02 Method B)

A one inch by three inch sample is bonded to 2 inch by 6 inch stainless steel panels with a 0.5 inch tab left unbonded. The samples are mounted in an INSTRON® Universal Material Test Machine Model No. 5567, (Instron Corporation, Canton, Mass.) with an environmental chamber attachment. The chamber is set for 105° C. and allowed to come to temperature. The unbonded tab is bent 900 and secured to the upper grips. The plate is secured to the lower grips 90° to the upper grips. A crosshead speed of 1 inch per minute is used and the average peel strength (measured in pounds per linear inch, or pli) is recorded.

Test for Colonization of Bacteria

Bacteria colonization testing is carried out using a mixed culture biofilm formed by a Listeria cocktail and Pseudomonas putida. The Listeria cocktail consists of a Listeria monocytogenes, G3990, Scott A, YM96, 12374, and G3982. To prepare the inoculum, a bead from each culture is placed in separate tubes containing 10 ml of tryptic soy broth (TSB) and incubated for 24 hours at 32 EC. From this tube, 100 ml is transferred to fresh TSB and incubated as before. After two transfers, 2 ml of culture is then used to innoculate 200 ml of 10% TSB. This is then incubated at 32 EC for 24 hours and then used to prepare the biofilms.

Biofilms are produced on test surfaces cut into 7.5 by 11 cm coupons. These surfaces include a stainless steel control (type 304, #4B finish coated stainless steel). The coupons are first cleaned by immersion in 100 ml/L solution of Micro-90 Soap at 80 EC for one hour with sonication. Coupons are then rinsed in deionized water followed by sonication in 1.5% phosphoric acid solution at 80 EC for 20 minutes, and rinsing in deionized water. Clean coupons are then sanitized by submerging in deionized water and steaming for 30 minutes, followed by soaking in ethanol for 5 minutes and allowing to air dry.

Sterile coupons are placed in a flat sterile stainless steel pan and immersed in the 1 L combined inoculum of the five strains of L. monocytogenes and 200 ml of P. putida. The stainless steel is incubated with the L. monocytogenes cocktail and P. putida for 4 hours at 25 EC to allow attachment. The coupons are then rinsed with sterile phosphate buffer to remove unattached cells. They are then immersed in 1 L of 10% TSB and incubated at 25 EC for 48 hours to allow biofilm growth. After incubation the coupons are rinsed with sterile phosphate buffer and placed into another sterile pan, immersed in sterile non-fat dry milk and allowed to incubate at 32 EC for 2 hours. Following this final incubation, the coupons are again rinsed in sterile buffer and are ready for sanitizer treatment. To sanitize, biofilm containing coupons are immersed in 200 ppm Quaterary ammonium sanitizer for 5 minutes at room temperature. After this holding time, coupons are neutralized by submersion in a Lecithin/Tween 80° solution followed by rinsing with sterile phosphate buffer. Once sanitized, coupons are allowed to dry at room temperature.

Enumeration of surviving Listeria is determined, once the coupons are dry, by agar overlaying the coupons with Plate Count Agar with 0.1% potassium tellurite and incubating at 35 EC for 24-48 hours. With this medium, Listeria colonies appear black and Pseudomonas growth is inhibited. CFU/50 cm is determined. Initial biofilm zero counts are obtained by scraping cells from a positive control using a TEFLON® scraper and rinsing with 100 ml sterile phosphate buffer. This rinse solution is collected, serial diluted and placed on a petri dish containing Plate Agar Count with 0.1% Potassium Tellurite.

Without intending to limit the scope of the present invention, the following examples illustrate how the present invention may be made and used:

### EXAMPLES

### Example 1

A 4 inch by 4 inch sample of 60×60 wire mesh with 6.5 mil diameter 304 stainless steel wire (MSC Industrial Supply Co.) was laminated on a Carver Press to a composite film of densified expanded PTFE and THV 500 (PTFE layer 10 um thick, density of about 2.3 g/cc/THV layer 10 um thick, W. L. Gore and Associates, Inc. Elkton, Md.) using a 2 mil thick film of THV Grade 220 (Dyneon, Inc.) to laminate the mesh and composite film together. The layers were pressed at 180° C. for 15 minutes under 2.5 tons of force.

A layer of Dymax 621 UV curable adhesive (available from Dymax, Inc) was applied to a one inch width area of the stainless steel panels described int eh Peel Strength Test. The sealing material was then pressed into the UV adhesive and placed through a UV cure unit (Model No. LC-6B, Fusion UV Systems, Inc).

The bonded composite was found to have a peel strength >7 pli at 105° C.

### Examples 2

A sealing material was prepared as indicated in Example 1, except that a 150×150 wire mesh composed of 2.6 mil diameter 304 stainless steel wire was used.

The resulting sealing material was found to have a peel strength <3 pli at 105° C. (check peel strength).

### Example 3

A sealing material was prepared as indicated in Example 1, except the adhesive layer was changed to a thermal curing hot melt adhesive, namely Collano VN562 melt processable reactive polyurethane (available from Collano, Inc.). The adhesive and and composite layers were laminated and cured at 160° C. for ½ hour in a forced air convection oven.

The resulting sealing material was found to have a peel strength >5 pli at 105° C. (check).

### Example 4

A sealing material was prepared as indicated in Example 1, except the adhesive layer was changed to a curable pressure sensitive adhesive, namely 3M's 9245 (20 mil) structural bonding transfer tape (available from 3M). The pressure sensitive adhesive and other layers was laminated at room temperature using a laboratory laminator.

The sealing material was cut into 1 inch strips and rolled onto stainless steel plates with a 4.5 lb rubber roller. The laminated construction was then cured at 150° C. for 1 hour. The bonded composite was found to have a peel strength >5 pli at 105° C.

While particular embodiments of the present invention have been illustrated and described herein, the present invention should not be limited to such illustrations and descriptions. It should be apparent that changes and modifications may be incorporated and embodied as part of the present invention within the scope of the following claims.

1. A layered article comprising
a fluoropolymer layer having a surface energy of 25 dynes/cm or less, a water contact angle of 100° or greater and which is substantially free of pores;
a composite layer comprising a thermoplastic polymer impregnated at least partially into a metal mesh, said composite being bonded to said fluoropolymer layer; and
an adhesive bonded to said composite layer.

2. The article of claim 1, wherein said adhesive has a peel strength of at least 5 pli at a temperature of about 220° F.

3. The article of claim 1, wherein said adhesive has a peel strength of at least 7 pli over a temperature range of about 32° F. to about 220° F.

4. The article of claim 1, wherein said adhesive comprises a thermosetting material.

5. The article of claim 1, wherein said adhesive comprises a UV-curable material.

6. The article of claim 1, wherein said thermoplastic polymer comprises a thermoplastic fluoropolymer.

7. The article of claim 1 in the form of a tape.

8. The article of claim 1 in the form of a sheet.

9. A layered article comprising:
a layer of polytetrafluoroethylene having a bulk polytetrafluoroethylene density of 2.11 g/cc or more, said layer being substantially free of pores;
a composite layer comprising a thermoplastic polymer at least partially inmpregnated into a metal mesh and bonded to said polytetrafluoroethylene layer; and
an adhesive bonded to said composite layer.

10. The article of claim 9, wherein said adhesive has a peel strength of at least 5 pli over a temperature range of about 32° F. to about 220° F.

11. The article of claim 9, wherein said adhesive has a peel strength of at least 7 pli over a temperature range of about 32° F. to about 220° F.

12. The article of claim 9, wherein said adhesive has a peel strength of at least 5 pli over a temperature range of about 32° F. to about 220° F.

13. The article of claim 9, wherein said adhesive comprises a thermosetting material.

14. The article of claim 9, wherein said adhesive comprises a UV-curable material.

15. The article of claim 9, wherein said thermoplastic polymer comprises a thermoplastic fluoropolymer.

16. The article of claim 9 in the form of a tape.

17. The article of claim 9 in the form of a sheet.

18. A layered article comprising
a fluoropolymer layer having a surface energy of 25 dynes/cm or less, a water contact angle of 100° or greater and which is substantially free of pores;
a composite layer comprising a thermoplastic polymer impregnated at least partially into a porous support material, said composite being bonded to said fluoropolymer layer; and
an adhesive bonded to said composite layer.

19. The article of claim 18, wherein said adhesive has a peel strength of at least 5 pli at a temperature of about 220° F.

20. The article of claim 18, wherein said adhesive has a peel strength of at least 7 pli over a temperature range of about 32° F. to about 220° F.

21. The article of claim 18, wherein said adhesive comprises a thermosetting material.

22. The article of claim 18, wherein said adhesive comprises a UV-curable material.

23. The article of claim 18, wherein said thermoplastic polymer comprises a thermoplastic fluoropolymer.

24. The article of claim 18 in the form of a tape.

25. The article of claim 18 in the form of a sheet.
